(19) United States
(12) Patent Application Publication
(10) Pub. No.: US 2017/0118101 A1
(43) Pub. Date: Apr. 27, 2017

(54) Internet Access Evaluation

(71) Applicant: Google Inc., Mountain View, CA (US)

(72) Inventors: Maxime Veron, Los Altos, CA (US); Matthew Lee Rogers, Los Gatos, CA (US); Gregory J. Hu, Los Altos, CA (US)

(21) Appl. No.: 14/920,636

(22) Filed: Oct. 22, 2015

(51) Int. Cl. H04L 12/26; H04W 28/02; H04L 12/24

(52) U.S. Cl. CPC H04L 43/0888; H04L 41/5038; H04L 43/0882; H04W 28/021

(57) ABSTRACT

An electronic device includes a processor configured to obtain first speed test results by measuring throughput of data of a first Internet service for a first home environment. The processor is configured to determine a recommendation by comparing the first speed test results with second speed test results of a second Internet service of a second environment. The processor may then provide an indication of the recommendation (e.g., on a display) of the electronic device.

### BACKGROUND

This disclosure relates generally to Internet services and, more particularly, to evaluating the performance of Internet services provided to an environment.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A large number of customers in homes, businesses, and schools use the Internet in a wide variety of situations, such as VoIP calls, sending emails, browsing the web, downloading/uploading files, or streaming movies. Typically, to receive access to the Internet, a customer buys a plan with Internet services from an Internet Service Provider (ISP), and the plan describes the speed at which data will be delivered to the customer. When the data is sent to the home faster, then web pages load faster, downloads take less time, and movies run smoother with less latency.

However, some customers may receive poor Internet services from their ISP. In some cases, the customer may be receiving/sending data slower than the plan that the ISP described, causing slower download and/or upload speeds resulting in more problems for the customer. For example, if the customer is watching a streaming movie to their television at home and the ISP is providing poor services, the loading bar at the bottom of the movie may slow, the quality may deteriorate, or the movie may freeze, resulting in wasted time and a poor experience for the customer.

Unfortunately, customers may not know whether the poor speeds are caused by the electronic devices, poor wireless signal or connection in the home, or by the ISP. When slow upload and/or download speeds occur, the customer often does not know the underlying cause of the problem. If poor Internet service is provided because of the ISP, there is little information of whether poor service was provided to only the customer house or if service was congested on multiple homes (e.g., due to too much traffic). Accordingly, little feedback is provided regarding the health of Internet connectivity for the customer's home. Moreover, any feedback available may be subjective, inaccurate, or incomplete and, thus, it provides little help to the customer. For the foregoing reasons, there is a need to provide better feedback to customers regarding the performance of their network.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure is directed to a system and method that addresses the need to provide objective, accurate, location-based feedback to customers regarding the performance of the customer's network (e.g. ISP) compared to others. To provide such feedback, an electronic device may have a processor that is configured to execute instructions to determine how an ISP is performing in an environment, such as the user's home or business. The processor may perform one or more speed tests to assess performance of the ISP, the electronic device, or the WiFi network. In some cases, the speed test results may be aggregated (e.g., summed, averaged, etc.) to provide an assessment of the environment's Internet connectivity. The processor can then provide a recommendation of how to improve the electronic device, network, and/or Internet services allowing the environment to have improved data communication speeds.

The processor may identify the ISP and the plan used by the environment based on the speed test results. Then, the processor may identify other ISPs in the area and compare the performance of Internet services from the current ISP to the performance of other ISPs (e.g., other ISPs available in the area). For example, the processor may utilize a zip code and an IP address of the home to determine current and/or available ISP options for the home. The processor may incorporate each plans pricing and data rates when providing the recommendation.

As a result, customers have more knowledge about the Internet services that they receive. With better knowledge, the customer can change plans to save money and/or improve Internet connectivity. Further, the customer can know which service outperforms competition. By testing connectivity, an embodiment may provide objective and accurate feedback to the customer. Further, by taking actual, objective measurements, the customer can fairly assess the Internet service without relying on advertised ISP data speeds. Additionally, using connectivity information from others can provide accurate information about ISP competitor performance.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 illustrates a block diagram of a home network connected to the Internet using an ISP, in accordance with an embodiment;

FIG. 2 illustrates a block diagram of electronic devices on the home network of FIG. 1, in accordance with an embodiment;

FIG. 3 illustrates a block diagram of a neighborhood connected to the Internet using ISPs, in accordance with an embodiment;

FIG. 4 illustrates a flow diagram of a process for obtaining better Internet service, in accordance with an embodiment;

FIG. 5 illustrates a flow diagram of an example of the process of FIG. 4 for comparing the home network of FIG. 1 with another home network to obtain better Internet service, in accordance with an embodiment;

FIG. 6 illustrates a block diagram of electronic devices in a wireless mesh network, in accordance with an embodiment;

FIG. 7 illustrates a flow diagram of a process used with the wireless mesh network of FIG. 6 for improving network speed, in accordance with an embodiment; and

FIG. 8 illustrates a flow diagram of an example of the process of FIG. 7, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

I. The Home Network

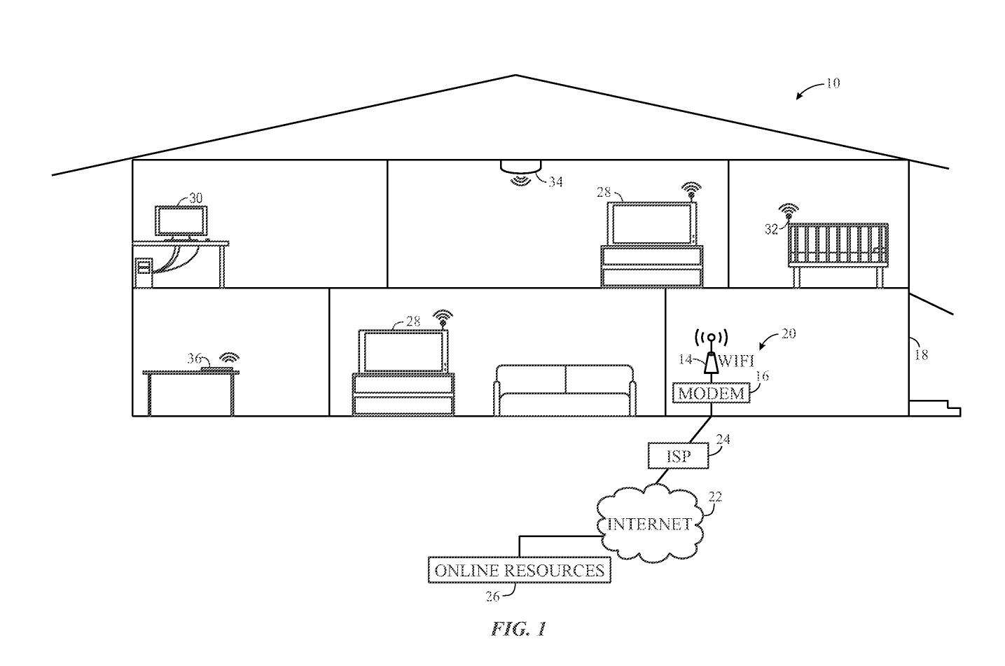

ISPs provide access to Internet services for electronic devices in various environments, such as a home, business, office, or school. By way of introduction, FIG. 1 illustrates a home environment 10 with one or more wired and/or wireless access points 14. The environment 10 may include a structure 18 such as a house, office building, restaurant, or hotel. It will be appreciated that devices can also be integrated into other types of environments 10 that do not include an entire structure, such as an apartment, condominium, office space, or the like. The access point 14 may be a WiFi router connected directly to a wired Ethernet connection in the structure 18 of the home environment 10. In some cases, the access point 14 may be wired or wirelessly coupled to a modem 16 that is used to allow devices to communicate with the Internet 22 via an ISP 24. In other cases, an electronic device 20 may include access point 14 circuitry and the modem 16 circuitry.

The ISP 24 can allow wired or wireless electronic devices of the home environment 10 to access various online resources 26 on the Internet 22. Typically, the customer (e.g., home occupant, office worker, business owner) pays an ISP to provide Internet service to the environment 10. Many ISPs 24 offer a variety of plans (e.g., low speed, medium speed, or high speed) that describe how much data can be sent to the home in a given time. Often, the ISP 24 will offer faster data rates for plans that cost more. Different ISPs can vary in their ability to deliver the data rates of their plans based at least in part on the technologies used (e.g., DSL, cable, fiber) and the congestion at the current time.

The home environment 10 may include a wide variety of electronic devices that can communicate with the access point 14 to upload and/or download data from the Internet 22 for a customer. While these electronic devices are shown and are described in detail below, any electronic device suitable for communicating with the Internet 22 may be used. For instance, the home environment 10 may include one or more televisions 28 that communicate with the Internet 22 to stream movies, songs, or other forms of media for the customer. Often, the home environment 10 may include one or more computers 30 to upload and/or download data on the Internet 22, such as data related to files, movies, games, web browsing, or emailing. Further, the home environment 10 may include one or more cameras 32. The camera 32 may be standalone or part of a security system for inside the home. For instance, the camera 32 may be located by a baby (e.g., baby monitor) so the parents can monitor the baby from anywhere in their house. As further example, various sensors 34 may be placed throughout the home environment 10, such as motion sensors, infrared sensors, smoke alarm sensors, or carbon monoxide sensors. The home environment 10 may also include a thermostat 36 (e.g., smart thermostat), such as a Nest® Learning Thermostat.

Some examples discussed below include various systems, apparatus, methods, and related computer programs for testing home connectivity using the thermostat 36. In addition to controlling the temperature of the home, the smart thermostat 36 may communicate with the Internet 22 to periodically test network speeds. It should be appreciated, however, that while many of the specific examples below relate to testing home connectivity using a thermostat 36, any suitable electronic device that can test home connectivity may employ the systems and methods of this disclosure.

II. Internet Service Providers

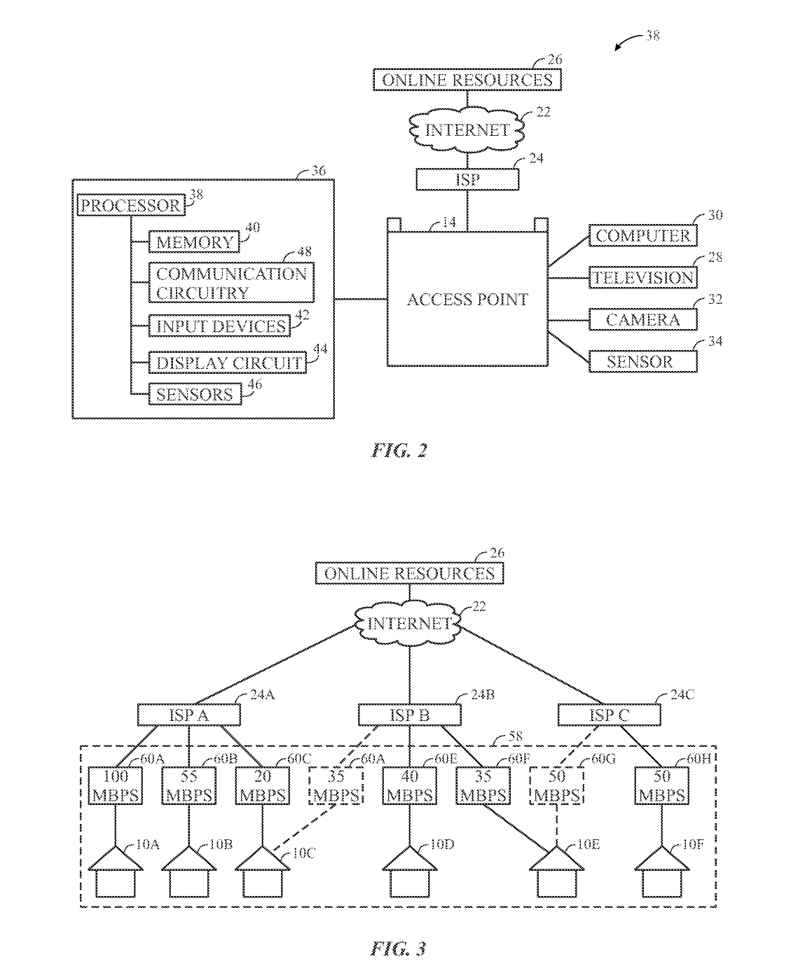

The access point 14 may transmit and/or receive data from the electronic devices of the network and/or the Internet 22. As shown in FIG. 2, the access point 14 may communicate with the television 28, computer 30, camera 32, or sensor 34. Further, the access point 14 may relay information between the Internet 22 and the electronic devices on the network. For instance, when watching a streaming movie on the television 28, the access point 14 may receive data from an online resource 26 on the Internet 22 and transmit the data to the television 28. Alternatively and/or additionally, the computer 30 may download a file using another online resource 26 on the Internet 22. The upload and/or download speeds can often depend on the access point 14, the ISP 24, the online resource 26, and/or the electronic device.

One or more of the electronic devices of the home environment 10 may test the network periodically to assess performance of the electronic devices, the WiFi, or the ISP. FIG. 2 shows a system 38 used to perform tests of network bandwidth or throughput (e.g., upload and/or download speed). While many of the specific examples below relate to testing home connectivity using the thermostat 36, any suitable electronic device (e.g., the computer 30, the television 28, the camera 32, the sensor 34) that can test home connectivity may employ the systems and methods of this disclosure. Further, the electronic device may upload data to the cloud to assess network performance (e.g., ISP performance). The thermostat 36 or other electronic device may have one or more processors 38 operatively coupled to memory 40. The one or more processors 38 may be configured to execute instructions (e.g., software or firmware) encoded in programs (e.g., code) and stored in a tangible, non-transitory computer readable medium (e.g., the memory 40) to perform the processes described below. The processors 38 may be general purpose processors, system-on-chip (SoC) devices, or application specific integrated circuits, or some other processor configuration. The memory 40 may include a computer readable medium, such as, without limitation, a hard disk drive, a solid state drive, a diskette, a flash drive, a compact disc, a digital video disc, random access memory (RAM), and/or any suitable storage device that enables the processor(s) to store, retrieve, and/or execute instructions and/or data.

The processor 38 may control operation of the thermostat 36 to generally manage the temperature of the home environment 10 according to the preferences of the customer. As shown in FIG. 2, the thermostat 36 also includes input devices 42 (e.g., knobs, wheels, touchscreens) to enable a user to directly interface with the thermostat 36 to provide customer temperature preferences and display circuitry 44 capable of presenting a graphical user interface (GUI) to display information to the user. Further, the illustrated thermostat 36 may also include a number of sensors 46, such as one or more temperature sensing devices, acoustic sensing devices, visible or IR sensing devices, vibration sensing devices, air pressure sensing devices, or EMI sensing devices. The thermostat 36 may also include communication circuitry 42 that allows the thermostat to communicate (e.g., via WiFi) with one or more electronic devices, such as the access point 14, in the network using radio waves. The communication circuitry 42 may include IEEE 802.xx (e.g., 802.11 a/b/g/n/ac) standards to communicatively couple the thermostat 36 to the wireless access point 14.

The processor 38 may provide customers an assessment of the performance of the network (e.g., the ISP 24 or the WiFi) by periodically testing upload and/or download speeds of the network. In other words, the assessment can give customers objective and accurate information about how the ISP 24 is performing. Further, the testing may be performed at preset time intervals over minutes, hours, days, weeks, months, or years. With periodic upload and/or download speed tests, the processor 38 can determine the health status of the network based on the speed tests throughout the day. For instance, if the processor 38 performs a speed test on 10 minute intervals throughout the day, the processor 38 can provide historical information about how data speeds change during congestion times (5 pm-7 pm) versus off peak hours (10 pm or later at night).

The processor 38 of the thermostat 36 may assess the network performance by testing upload and/or download speed to and/or from an online resource 26, such as a speed test website or server (e.g., speedtest.net or a proprietary website) that tests and identifies an upload and/or download speed of data. While the specific examples above is related to using a speed test website or server, any suitable way of testing upload and/or download speed may be employed in the systems and methods of this disclosure. The speed test website or server may send data to the thermostat 36 and the speed test website or thermostat 36 may determine how much time it takes for the thermostat 36 to receive the data. Similarly, the speed test website or server may then receive data from the thermostat 36 and the speed test website or thermostat may determine how much time it takes for the thermostat 36 to send data. As further example, the thermostat 36 may communicate with another thermostat and test how much time it takes to communicate an amount of data to be sent/received by the other thermostat.

Additionally and/or alternatively, the processor 38 of the thermostat 36 may test for ping from another electronic device. By pinging the online resource 26, another thermostat, or a server, the processor 38 can determine whether connections can be established to various devices at a given time. The processor 38 may use results from these ping tests to determine how often and when connections can be established. Further, the processor 38 may receive data from the ISP 24 related to problems with the service provided by the ISP 24. For example, the processor 38 may receive data related to known problems of the ISP during a test. As another example, the ISP may broadcast a status of connectivity. The processor 38 may receive the broadcasted status and track ISP status information and/or ISP problems.

III. Providing Recommendations

The processor 38 may obtain and utilize one or more speed test results of the thermostat 38 to provide a recommendation to improve network performance, such as Internet service or WiFi performance. For example, the processor 38 of the thermostat 36 or other electronic device may determine a health assessment of the performance of the customer's ISP based on the speed test results. For instance, the assessment may include historical data (e.g., speeds from the speed tests), statistics (average, maximum, or minimum download and/or upload speed, speeds at different times of day, speeds during congestion), pricing, data rate per dollar, graphs, charts, or any other suitable way to describe the performance of the Internet service. The assessment may then be used in recommending better Internet service.

Like the home environment 10 described above with respect to FIG. 1, there may be other homes that use a similar thermostat or other electronic device to periodically test network speeds as well. Further, the processor 38 may upload data to an online resource 26 in the cloud to be used for comparison purposes by a processor in the cloud. The processor 38 may compare the performance (e.g., speed test results) of the network with performances of other networks to identify which ISP and/or plan would provide better service to the customer. To identify the ISP 24 associated with the home environment, the processor 38 may obtain a zip code and an IP address (e.g., from the memory 40 or the input devices 42) of the home environment 10. While using zip codes is suggested herein, other embodiments may utilize a city, county, or other area to help find information related to ISPs. Further, the processor 38 may identify other ISPs available by using the zip code and/or the IP address. As shown in FIG. 3, a neighborhood 58 may include service from one or more ISPs 24, such as ISP 24A, ISP 24B, and ISP 24C. Customers of home environments 10A, 10B, and 10C receive Internet service from ISP 24A, home environments 10D and 10E receive Internet service from ISP 24B, and home environment 10F receives Internet service from ISP 24C. The processor 38 of the thermostat 36 or other electronic device of the home environments 10A-10F of FIG. 3 may perform speed tests to determine the ISP and/or the Internet service plan.

The plan and/or a provider of a home environment 10 may be determined based on the speed test results, zip code, and/or IP address. The processor 38 may receive inputs from a customer of a zip code, IP address, or ISP information using the input devices 42, or the processor 38 may establish the plan and/or provider based on speed test results, zip code, and/or IP address. For instance, the processor 38 may identify a provider associated with an IP address and/or zip codes. With respect to FIG. 3, the processor 38 of environment 10A may determine the ISP based on the IP address assigned to devices (e.g., modem 16, thermostat 36) in the environment 10A. If the IP address is associated with a particular ISP, then the processor 38 may determine that ISP 24A provides Internet services to the environment 10A. In some cases, the processor 38 may utilize an online resource 26 that identifies which IP addresses are associated with certain providers.

By periodically testing download and/or upload speeds, a maximum upload and/or download speed may be determined, which can be used to determine the plan of the provider. The processor 38 may compare the upload and/or download speed test results to speeds associated with the ISP plans. For instance, ISP 24A offers three plans: a high speed (100 Mbps), a medium speed (60 Mbps), and a low speed (40 Mbps) plan. If the speed tests 60A of the home environment 10A indicate average download speeds or maximum speeds of 100 Mbps, then the home environment 10A may have the high speed plan, as the other plans do not allow speeds that high. Similarly, if the speed test 60 of the home environment 10B indicates average download speeds or maximum speeds of 55 Mbps, then the speed tests suggest that the home environment 10B has a medium speed plan, because the speed is above the maximum low speed plan and not as high as the high speed plans. Further, speed tests 60C of the home environment 10C may indicate average speeds or maximum speeds of 20 Mbps. As the speed test results have speeds less than the lowest plan, the home environment 10C most likely has a low speed plan. In similar fashion, home environments of ISP 24B and 24C have speed tests (e.g., 60E, 60F, and 60H) to establish that the homes environments associated with ISP 24B have 40 Mbps plans and the homes associated with ISP 24C have 50 Mbps plans.

The plan, ISP, and performance (e.g., the speed test results or other aggregated data) of the network may be shared with an online resource 26 or the thermostats 36 of other home environments 10. Customers may opt-in to the resource 26 to share their data to better improve Internet services by agreeing to opt-in on a prompt on the thermostat 36 or perform other actions suitable to indicate a willingness to share data related to network speeds. The data may then be aggregated, based on zip code, plan, and speed, to provide further statistics about the performance of the Internet service providers. For instance, the data speeds of the environments of ISP 24B may be averaged to reflect 35 Mbps to allow more accurate comparisons. By sharing data with the service 18 or thermostat 36, the system 30 may allow the customer to receive recommendations to improve their service.

The performance of the network may then be compared with one or more neighbor networks of the same zip code to determine if there is a better service for the customer. As described above, neighbor speed tests may be aggregated to encompass more houses to establish more reliable statistics (e.g., averages, sums, standard deviation, distributions, etc.). The performances may be compared in a variety of ways, such as comparing average upload and/or download speeds for similarly priced plans. For instance, if ISP 24B offers a similarly priced plan to the low speed plan of ISP 24A, then the customer of home environment 10C may receive better Internet service (e.g., going from average rates of 20 Mbps to 35 Mbps based on the aggregated data) by changing to ISP 24B. To determine what service is better, the system 30 may account for price of a plan, speeds of a plan, discounts or specials for a plan, congestion, data consumption, data caps, or congestion times of the plan versus usage times of the customer.

While faster speed for a similar price is used as an example of better service, any service that is more suitable for the customer may be recommended. For example, a more affordable plan that offers similar speeds may be considered a better service. For instance, if the data speeds are measured to be in a similar range (e.g., +/−5 Mbps), the speed may be considered similar. Further, if customer usage coincides with peak congestion times, a service that provides better speeds during congestion times may be recommended as better service. Similarly, if customer usage is typically off peak congestion times, a busier service may be recommended despite the congestion if it offers a better overall Internet service for that customer. As further example, as shown in FIG. 3, while ISP 24C offers a faster rate and costs the customer of home environment 10E more than the current ISP 24B, it may be beneficial to the customer to switch to ISP 24C because the customer consumes a large amount of data. Accordingly, the recommended service may offer a better value to the customer. Further, in an embodiment, the processor 38 may weigh the attributes above and recommend an Internet service that better align the attributes with how customer would weigh the attributes. For instance, the one or more attributes may be given weights (e.g., 50% price, 40% speed, 5% data cap, 5% congestion speeds) that each factor into an overall assessment.

The processor 38 of the thermostat 36 may also be configured to determine a home occupancy status to recommend service based on when occupants are home. Frequently, service is more important to an occupant when the occupant is at home, because the occupant does not want to wait for time sensitive data, such as slow loading bars for a movie, VoIP phone calls, or streaming music. As such, the processor 38 may determine a status which indicates a likelihood that there are one or more occupants in the home environment 10 and/or that any of the occupants are asleep. Referring back to FIG. 1, one or more of the electronic devices may be used to detect home occupancy. For instance, home occupancy may be based on network activity, sensor activity, smart appliances, GPS tracking, shared scheduling, time of day, weekday versus weekend, or any other suitable means for detecting home occupancy. The processor 38 of the thermostat 36 may detect the presence or activity of certain devices communicating on the communication network hosted by the wireless access point 14. As an example, if a occupant adjusts the temperature of the thermostat 36, there may be an increased likelihood that occupants are at home and awake. As a further example, the thermostat 36 or access point 14 may be able to detect network traffic being generated by the computer 30, television 28, sensors 34, or any other networked device of the home environment 10, which may be used as a measure of occupancy and/or occupant activity to determine a probability of occupancy and/or an occupancy probability profile within the home environment 10. In some cases, a spike in network traffic by one or more of the devices may indicate that an occupant is actively using the device (e.g., television 28). By further example, the thermostat 36 may receive information regarding the current location (e.g., global positioning system (GPS) coordinates or cellular phone location coordinates) of the occupant from one or more electronic devices which may be used to determine activity of the occupant. The processor 38 may recommend service based in part on home occupancy status to account for performance (e.g., faster data rates) when the occupant is home. For instance, if an occupant is typically gone from 9 A.M-5 P.M., the data rates may be less relevant to the occupant than the data rates when the occupant is present watching television 28 or making a VoIP phone call.

An electronic device may receive poor service because of poor WiFi connectivity. For example, referring back to FIG. 1, if the computer 30 receives poor Internet service compared to the television 28, the performance problems may be related to interference or distance to the access point 14. As such, each of the devices may perform speed tests and data analysis similar to those described above. Then, the speed test information may be sent to the thermostat 38 or other device to determine whether WiFi connectivity can be improved (e.g., based on WiFi signal strength). In the example above, if the speed tests indicate that the WiFi connectivity of the computer 30 could be improved, then the processor 38 can provide a recommendation to relocate the computer 30 closer to the access point 14 or add a repeater/amplifier to improve signal strength.

The processor 38 of the thermostat 36, or other electronic device, such as one of the online resources 26 (e.g., a server, service, database, etc.), may be configured to (e.g., running code) improve network performance by executing instructions (e.g., running code) that performs the steps of process 64 of FIG. 4. The process 64 may begin by obtaining performance data for the network (e.g., Internet service performance or WiFi connectivity) (block 66). The data (e.g., the speed test results during peak traffic hours) may be shared with the online resource 26 or an electronic device, such as a thermostat of the other home environments 10.

The processor 38 may then proceed to determine whether performance can be improved (block 68), for example, by determining whether there is an ISP with a better throughput/bandwidth and similar pricing, less congestion during peak times, lower priced plans, or the like. The processor 38 may determine if service is better by comparing speed test results for the home environment with results from other devices or services. For example, neighbor speed test results of the same zip code may be shared with the online resource 26. Once the speeds are compared, the processor 38 may provide an indication of a recommendation (block 70). The recommendation may be a report, a prompt on the display of the thermostat 36, an email message, text message, or any suitable indication for conveying that one ISP is offering better service than another ISP.

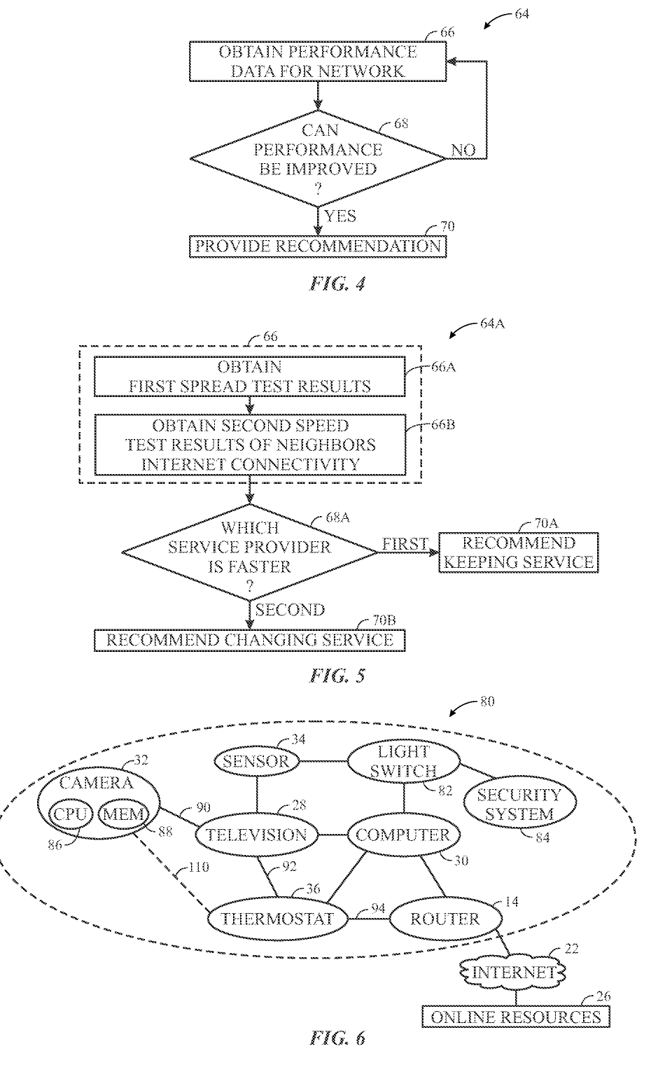

The Internet service may be recommended based on which service is faster. While speed is used to recommend better service below, service may be recommended for a variety of reasons discussed above. FIG. 5 is an example of a process 64A that performs the steps of FIG. 4. The processor 38 may begin by obtaining the health status of the Internet service (block 66). The processor 38 may obtain a first speed test result (block 66A) of the home environment 10. The processor 38 may then obtain a second speed test result of neighbor (e.g., home environment in the same or nearby zip code) Internet connectivity (block 66B). The processor 38 may then determine which provider is faster (block 66A). For instance, if speed test results from the home environment from block 66A are on average faster than the speed test results of the second home environment from block 66B, then the processor 38 may provide an indication of recommending that the customer keep the current ISP (block 70A). If the processor 38 determines that the speed test results received from the neighbor's home environment (block 66B) are on average faster than the speed test results of the home environment (block 66A), then the processor 38 may provide an indication of recommending that the customer change services (block 70B).

IV. Wireless Mesh Networks

Speed tests may also be used within a wireless mesh network for a processor 38 improve connectivity in an environment. FIG. 6 shows a wireless mesh network 80 (e.g., a fabric network) that operates without a central communication hub (e.g., the access point 14 of FIG. 1), as two or more devices in the wireless mesh network 80 can perform such communication tasks. As an example, the wireless mesh network 80 may include a camera 32, television 28, thermostat 36, sensor 34, computer 30, router 14, light switch 82, and security system 84. While the camera 32 and the thermostat 36 are described in detail below, any or all of the electronic devices may be suitable to perform the process described below.

As with the thermostat 36 described above, the camera 32 and the thermostat 36 may include a processor 86 operatively coupled to a memory 88 to execute instructions (e.g., code) stored thereon. The mesh network 80 may enable the devices to communicate with each other via one or more logical networks (e.g., an IEEE 802.15.4 network). As such, certain devices may serve as wireless repeaters and/or may function as bridges between devices, services, and/or logical networks in the home environment 10 that may not be directly connected (i.e., one hop) to each other. In other words, some of the electronic devices may act as wireless mesh access points (i.e., intermediary devices that relay data). The electronic devices of the wireless mesh network may communicate as set forth according to the techniques disclosed by U.S. patent application Ser. No. 13/926,335, entitled “Efficient Communication for Devices of a Home Network” and filed on Jun. 25, 2013, which is incorporated by reference herein in its entirety for all purposes.

In a wireless mesh network, several or all of the electronic devices may be capable of data communications and information sharing with other devices within range, as well as to online resources 26 or other devices that may be network-connected anywhere in the world. The devices may send and receive communications via the wireless mesh network 80 (e.g., fabric network). For example, the camera 32 may be able to communicate with the devices within range, such as the television 28. The television, may act as an intermediary and send data from the camera 32 (e.g., delivered via hop 90) to the thermostat 36 (e.g., hop 92). In some cases, the data may be interpreted by the thermostat 36. In other cases, the data may be sent to the router 14 (e.g., hop 94) via the thermostat 36 to be delivered to an online resource 26 on the Internet 22.

Because of distance, interference, or throughput limitations, the camera 32 may have difficulties transmitting or receiving data. For example, if the camera 32 is located too far from the television 28, error rates may increase due to the distance. As further example, the television 28 may have limited abilities to route data for the camera 32, perhaps due to too much traffic through the television 28 (e.g., streaming television show or data from the sensor 34). As such, the difficulties transmitting or receiving may result in delays, loss of data, or reduced quality.

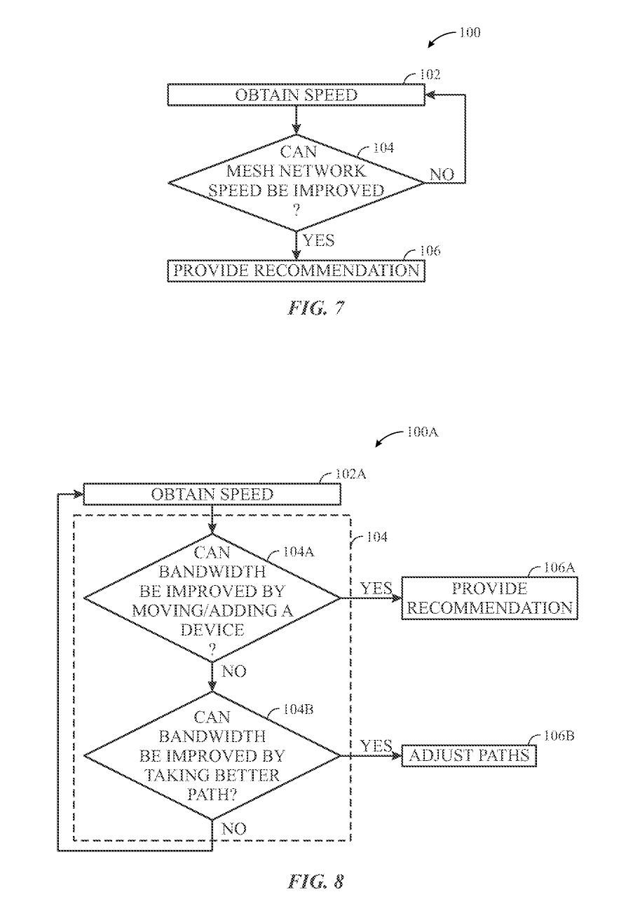

To address these difficulties, one of the electronic devices, such as the thermostat 36, may provide a recommendation to improve wireless mesh network traffic. FIG. 7 is an example of a process 100 performed by one of the processors 38, 86 of the wireless mesh network 80 or an online resource 26. The process 86 may begin by obtaining data (block 102) related to the speed of the network (e.g., traffic transmitted/received through the mesh network 80). The processor 86 of the camera may be configured to periodically perform speed tests, via the wireless mesh network 80, to one or more other electronic devices. For example, the speed tests may utilize the time it takes a preset amount of data to reach the thermostat 36 through the television 28 (e.g., via hops 90 and 92). Based on the speed tests, the processor may determine whether network speed can be improved (block 104). If the network speed cannot be improved, the process 86 may begin again by obtaining speed data (block 102). If the processor determines that there is a way that network speed can be improved, the processor may provide an indication of a recommendation (block 106).

The recommendations could be related to locations of the mesh devices or the paths that the data takes in the network. As an example of the process 100 described above, FIG. 8 shows a process 100A that begins by obtaining data (block 102A) related to the bandwidth allowed between devices of the wireless mesh network 80. For example, in FIG. 6, the sensor 34 may perform speed tests with the television 28 and the light switch 82 to determine which path allows for higher bandwidth through the mesh network 80. Further, the system may accommodate for AC powered and battery powered devices. For instance, if the light switch 82 is battery powered, the sensor 34 may perform speed tests more sparingly (e.g., perform speed tests 10% as often). Further, if signals indicate that the battery power of the light switch 82 is low, then the speed testing by the sensor 34 may be reduced based on the battery power. In addition or alternative to speed tests, the processor of an electronic device in the mesh network may identify bandwidth based on signal strength between devices.

The process 100A may continue by determining whether network speed can be improved (block 104). In FIG. 6, the processor 86 of an electronic device, such as the camera 32 or the sensor 34, may determine whether bandwidth can be improved by moving/adding a device (block 104A). For example, with respect to FIG. 6, if signal strength or speed tests indicate poor bandwidth between the camera 32 and the television 28, then the processor 86 of one of the electronic devices of the mesh network 80 or the online resources 26 may provide a recommendation (block 106A) to move the camera 32 closer to the thermostat 36 such that the two devices may communicate (e.g., via mesh link establishment 110). Further, if bandwidth can be improved by taking a better path (block 104B), then the processor may recommend to the customer or other electronic devices that paths may be adjusted (106B).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method, comprising:
obtaining first speed test results by measuring the throughput of data of a first Internet service of a first environment;
determine a recommendation by comparing the first speed test results with second speed test results of a second Internet service of a second environment; and
providing an indication of the recommendation.

2. The method of claim 1, wherein the indication comprises a displayed suggestion to a user to utilize the second Internet service in place of the first Internet service based on the first and second speed test results.

3. The method of claim 1, comprising establishing a plan associated with the Internet service based on the first speed test results, wherein the plan comprises a price and a predicted speed.

4. The method of claim 1, comprising determining the second environment based at least in part on a zip code of the first environment.

5. The method of claim 1, comprising aggregating the speed measured through the first Internet service with other measured speeds to determine statistics, forecasts, or historical data to be utilized as the first speed test results.

6. The method of claim 1, wherein the recommendation is based on a status associated with the environment that indicates a likelihood that occupants are away from the home or asleep.

7. The method of claim 1, wherein the speed comprises an upload speed, a download speed, or any combination thereof.

8. The method of claim 1, wherein the indication is provided to an electronic device via the first Internet service.

9. An electronic device, comprising:
a processor configured to:
obtain first speed test results by measuring throughput of data of a first Internet service for a first home environment;
determine a recommendation by comparing the first speed test results with second speed test results of a second Internet service of a second environment; and
provide an indication of the recommendation on a display of the electronic device.

10. The electronic device of claim 9, wherein the recommendation is based at least in part on a plan predicted based on the speed and a zip code of the first home environment

11. The electronic device of claim 10, wherein the recommendation is based at least in part on a price and speed of the plan.

12. The electronic device of claim 9, wherein the recommendation is based at least in part on congestion, data caps, or congestion times of the first Internet service.

13. The electronic device of claim 9, wherein the processor is configured to receive an indication of an opt-in for sharing data prior to determining the recommendation

14. The electronic device of claim 9, wherein the processor is configured to account for data consumption of the environment when determining the recommendation.

15. The electronic device of claim 9, wherein the first test results are obtained by measuring the amount of data received by the electronic device in a given amount of time.

16. One or more non-transitory, computer readable media encoding one or more processor-executable routines, wherein the one or more routines, when executed by a processor, cause the acts to be performed comprising:
obtain speed test results configured to indicate throughput of data received or sent by a first electronic device of a network;
determine whether the throughput can be improved by adjusting one or more settings of the network, wherein the settings comprise at least one of:
a location of the first electronic device or a second electronic devices of the network,
a number of electronic devices on the network,
a path of communication utilized by the data of the first electronic device, and
an ISP that provides Internet services to the network; and
providing an indication of a recommendation to adjust the one or more settings.

17. The non-transitory computer readable media of claim 16, wherein adjusting the location or the number is based on wireless signals of the first electronic device.

18. The non-transitory computer readable media of claim 16, wherein the recommendation comprises the ISP when speed test results indicate that another ISP provides more throughput.

19. An electronic device configured to communicate in a wireless mesh network, comprising:
a processor operatively coupled to a memory, wherein the processor is configured to:
obtain speed test results by measuring a rate of data through an at least one link of the wireless mesh network;
determine a recommendation based on whether the rate can be improved by adjusting one or more settings of the wireless mesh network; and
provide an indication of the recommendation to a user or another electronic device of the wireless mesh network, wherein the indication comprises the one or more settings to adjust.

20. The electronic device of claim 18, wherein the electronic device is configured to obtain speed test results at an interval that depends on a power source of the electronic device or the at least one other electronic device.

21. The electronic device of claim 19, wherein the interval is less frequent when the power source comprises a DC power source than when the power source comprises an AC power source.

22. The electronic device of claim 20, wherein the interval depends on a state of charge of the DC power source.
